(19) United States
(12) Patent Application Publication
(10) Pub. No.: US 2006/0151605 A1
(43) Pub. Date: Jul. 13, 2006

(54) Label information storage

(75) Inventors: Satoru Miyoshi, Ora-gun (JP); Akira Tsukihashi, Ora-gun (JP)

Correspondence Address: PILLSBURY WINTHROP SHAW PITTMAN LLP, P.O BOX 10500, McLean, VA, 22102, US

(73) Assignee: SANYO ELECTRIC CO., LTD., Osaka (JP)

(21) Appl. No.: 11/324,409

(22) Filed: Jan. 3, 2006

(30) Foreign Application Priority Data
Jan. 12, 2005 (JP) 2005-005164

(51) Int. Cl. G06K 7/10

(52) U.S. Cl. 235/454

(57) ABSTRACT

One of a first laser driver and a second laser driver for respectively driving a first laser light source and a second laser light source is selected according to a type of storage media constituting an object of processing, drive pulses are generated from that laser driver based on label information, and label information is written to a label layer of the storage media, constituting an object of processing, using laser light output by driving a laser light source with these drive pulses.

### CROSS-REFERENCE TO RELATED APPLICATIONS

The entire disclosure of Japanese Patent Application No. 2005-5164 including specification, claims, drawings, and abstract is incorporated herein by reference.

### BACKGROUND OF THE INVENTION

1. Field of the Invention

The present invention relates to a label information storage unit for storing label information to a label layer of a storage medium provided with a label layer capable of storing label information as a visible image using irradiation of laser light. The present invention relates particularly to a label information storage unit for storing label information of a storage medium drive provided with an optical pickup for outputting laser light of two mutually different first and second wavelengths.

2. Description of the Related Art

Currently, DVD drive units for carrying out storage playback of a DVD (Digital Versatile Disc) are popular, but this DVD drive unit must ensure compatibility with discs besides DVDs, such as CDs (Compact Disc) as object storage media. As an optical pickup used in these DVD drives, two types of laser light are adopted, having differing laser light wavelength between a laser diode for emitting a laser beam of a wavelength suitable for DVD storage density, and a laser diode for emitting a laser beam of a wavelength suitable for CD storage density, and DVDs and CDs having different storage densities are handled with a single optical pickup, by switching a light source used depending on the disc storage density being handled.

With DVDs and CDs however, the thickness of a transparent substrate up to the storage layer is very different, by a factor of 2:1, being 0.6 mm and 1.2 mm respectively. In an optical pickup for handling DVDs and CDs, the NA (Numerical Aperture) required in an objective lens is different due to the optical characteristics respectively adopted for each disc. For this reason, in the case of respectively dealing with DVDs and CDs using a single objective lens, it is necessary to use an objective lens that operates at a respectively desired NA for each wavelength laser beam.

However, in order to make it possible to understand the content of disc information, label information conforming to that content is displayed on the disc.

In displaying the label information on the disc, it is common practice to print the label information or to write it on by hand, but recently technology has been developed to provide a label layer that is sensitive to laser light irradiated to a disc by an optical pickup, and storing label information using a visible image.

However, when storing a visible image of the label information on the disc, it can be assumed that the disc is turned over and laser light irradiated from an optical pickup is irradiated to the label layer from the label layer side. It is therefore necessary to turn the disc over.

Also, if it is necessary to turn the disc over to store label information, storage of main information and storage of label information are carried out in a time-divided manner for each data segment, and it is not possible to perform both storage operations at the same time, and there are the disadvantages with matching of main information storage and label storage information, and time and efficiency of the label information storage operation. There is therefore a need to enable label information storage to a label layer by irradiation of laser light from a storage layer side to the label layer without turning the disc over.

Also, a label information storage unit of a separate standard besides the label information storage unit of the related art has been proposed, and it is anticipated that if a label information storage unit meeting the previous requirements is implemented there will be an upsurge in label information storage units of various different standards.

Under these conditions, there is a mix of discs with various methods of attaching a label layer, and in label information storage units it is necessary to perform label information storage processing that is appropriate to the type of label layer the disc has.

### SUMMARY OF THE INVENTION

The present invention selects one of a first laser driver and a second laser driver respectively driving a first laser light source and a second laser light source according to a type of storage media constituting objects of processing, causes emission of a drive pulse from the selected driver based on label information, and writes label information to a label layer of storage media that is the object of processing using laser light irradiated due to the fact that the laser light source is driven by this drive pulse.

### BRIEF DESCRIPTION OF THE DRAWINGS

Preferred embodiments of the present invention will be described in detail based on the following drawings, wherein:

FIG. 1 is a block diagram showing an optical system and focusing system of an optical pickup device representing one embodiment of the present invention.

FIG. 2 is an explanatory drawing for describing the cross sectional structure of an R system storage disc.

FIG. 3 is an explanatory drawing for describing the cross sectional structure of a playback-only disc.

FIGS. 4A, 4B and 4C are explanatory drawings for describing a storage disc provided with label layer capable of storage.

FIG. 5 is a flowchart showing main processing for label information storage.

FIG. 6 is a flowchart showing processing when carrying out label information storage by turning over the disc.

### DESCRIPTION OF THE PREFERRED EMBODIMENTS

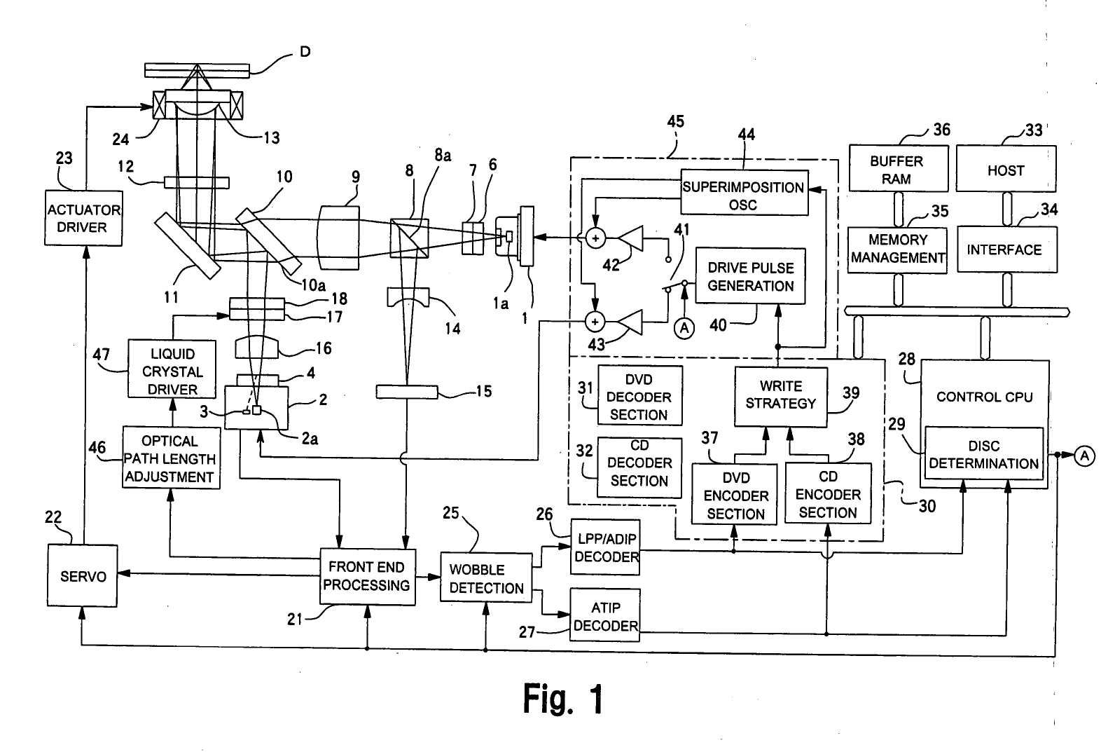

FIG. 1 is a block diagram of a label information storage unit of an optical disc type capable of storing and playing back DVDs and CDs, representing one embodiment of the present invention.

In the label information storage unit of FIG. 1, the optical pickup (optical pick up unit) is configured to handle DVDs and CDs. The optical pick up is provided with a laser unit 1 comprising a first laser diode 1a for emitting laser light of a first wavelength in the red wavelength band 645-675 nm appropriate to DVDs, for example 650 nm, and a light emitting and receiving unit 2 having a second laser diode 2a for emitting laser light of a second wavelength in the infra-red wavelength band 765-805 nm appropriate to CDs, for example 780 nm.

The light emitting and receiving unit 2 comprises a second laser diode 2a together with a photo detector 3 for receiving reflected light of the second laser light that is reflected from the disc. The second laser diode 2a and the photo detector 3 are contained in the same package. A hologram element 4, constituting an optical path separation element with a diffraction grating formed for carrying out optical path separation for separating reflected light of the second laser light from the optical path of the second laser light emitted from the second laser diode 2a and guiding it to the optical detector 3, is arranged in a window of the package. The diffraction grating for optical path separation is formed on a disc side surface of the hologram element 4, and a diffraction grating for separating a third beam uses for tracking control is also formed on a second laser diode 2a side of the hologram element 4.

Laser light of a first wavelength emitted from the first laser diode of the laser unit 1 is diffracted by the diffraction grating 6 to form ±1-order diffracted light used in tracking control, and after that has its direction of polarization adjusted to a direction that reduces birefringence of the transparent substrate of the disc by a ½ wave retardation plate 7 and is directed towards a polarization filter surface 8a of a polarization prism 8 from the direction of propagation. This polarization filter surface 8a has membrane characteristics set so that first laser light of a polarized direction adjusted by the ½ wave retardation plate 7 passes through. The first laser light therefore passes through the polarization filter surface 8a of the polarization filter 8, is converted to specular light by means of a collimator lens 9, and after that is supplied from the transmission direction to a parallel plate type beam splitter 10.

The beam splitter 10 functions to arrange the laser unit 1 and the light emitting and receiving unit 2 on separate optical paths. A filter surface 10a of the beam splitter 10 constituting a reflecting surface for reflecting the second laser light from the light emitting and receiving unit 2 has dichroic filter characteristics, making it wavelength selective, and is coated with a refection/transmission coat that passes substantially all of first laser light of wavelength 650 nm, but reflects almost all of second laser light of wavelength 780 nm.

As a result, first laser light emitted by the first laser diode 1a passes through the beam splitter 10, has its optical axis bent at a right angle by reflection using an diagonal mirror 11, and after that is incident on an objective lens 13 by means of a ¼ wave retardation plate 12 that is wavelength selective operating effectively only for first laser light of wavelength 650 nm, converged by the objective lens 13 and irradiated to a disc D.

First laser light modulated by the disc D and reflected returns to the objective lens 13, transmits via the light path it came on to the beam splitter 10, and returns to the polarizing prism 8 via the collimator lens 9.

First laser light that has returned to the polarizing prism 8 goes outward to the disc D and back again, passing twice through the ¼ wave retardation plate 12 having wavelength selectivity operating effectively only for the first laser light, and therefore the polarized direction is rotated ½ a wavelength. As a result, on the outward path to the disc D, first laser light, having p polarization, is changed to s polarization, and is made incident on the polarizing prism 8. First laser light returned to the polarizing prism 8 is therefore reflected by the polarizing filter surface 8a, and guided to the photo detector 15 via an anamorphic lens 14 for assigning an astigmatism component for the purpose of generating a focus error component.

The photo detector 15 receives first laser light, reflected by the disc D, on a light receiving surface that is divided into a plurality of light receiving regions, and various received light outputs required for forming a DVD storage signal, focusing control signal and tracking control signal, and a tilt control signal, are generated from the light receiving regions. A front end processing circuit 21 subjects the respective received light outputs of these light receiving regions to computational processing to create the DVD storage signal, focusing control signal and tracking control signal, and tilt control signal.

On the other hand, second laser light emitted from the second laser diode 2a of the light emitting and receiving unit 2 is separated into three beams by means of the hologram element 4, and output from the light emitting and receiving unit 2, and after having a spread angle adjusted using a divergent lens 16 is irradiated to the filter surface 10a of the beam splitter 10 by means of a liquid crystal lens 17 and a ½ wave retardation plate 18, and has its optical axis bent. Second laser light that has been bent by the filter surface 10a of the beam splitter 10 has the optical axis bent again to a direction perpendicular with respect to the disc surface, by being reflected by the diagonal mirror 11, is made incident on the objective lens 13 via a ¼ wave retardation plate 12, and then focused by the objective lens 13 and irradiated to the disc D.

Here, the objective-lens 13 has a diffraction grating (not shown) on an incident surface, and desired characteristics suitable for recording and reading of respective discs are realized for each laser having a different wavelength for DVD and CD by balancing refraction due to the diffraction grating and the aspherical shape of the objective lens 13 itself. In this case, first laser light suitable for DVD is incident on a specified region as parallel light, while the second laser light suitable for CD is incident on a specified regions as a specified spread angle, to exhibit desired characteristics so as to obtain NA appropriate for storing and reading from DVDs and CDs respectively and a laser spot that has been subjected to aberration correction.

Second laser light modulated by the signal surface of the disc D and reflected is returned to the objective lens 13, returned to the beam splitter 10 via the ¼ wave retardation plate 12 and the diagonal mirror 11, reflected by the filter surface 10a of the beam splitter 10, and is returned to the light emitting and receiving unit 2 via the ½ wave retardation plate 18, liquid crystal lens 17, and the divergent lens 16 again.

A laser beam that has returned to the light emitting and receiving unit 2 has its optical axis bent by the hologram element 4, and is received by the photo detector 3.

The photo detector 3 receives second laser light, reflected by the disc D, on a light receiving surface that is divided into a plurality of light receiving regions, and various received light outputs required for forming a CD storage signal, focusing control signal and tracking control signal are generated from the light receiving regions. A front end processing circuit 21 subjects the respective received light outputs to calculation processing to create the CD storage signal, the focusing control signal and the tracking signal.

The liquid crystal lens 17 is designed to operate as a lens by causing gradual concentric variation in the extent of phase variation using a liquid crystal array.

An outline of the disc structure will now be described in order to describe a focus servo system that will be described later.

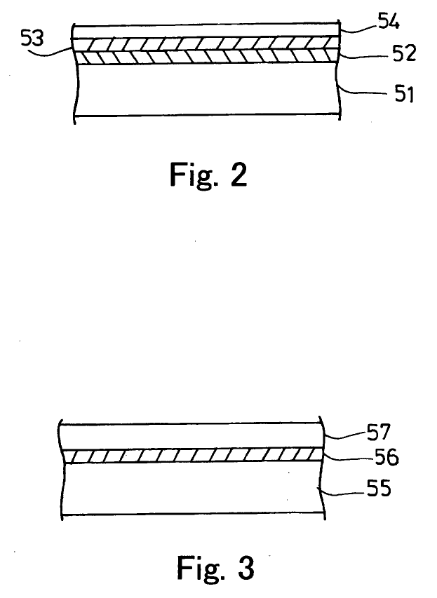

FIG. 2 is an explanatory drawing schematically showing the cross sectional structure of an R-type storage disc such as DVD-R/DVD+R and CD-R. In the case of DVD-R/DVD+R, the structure is two half-face discs laminated together, but only one of these half face discs is shown.

As shown in FIG. 2, an R-type storage disc has a transparent substrate layer 51, a storage layer 52, a reflecting layer 53, and a protective layer 54 sequentially laminated from an incident surface side where laser light from an optical pick-up unit is incident.

FIG. 3 is an explanatory drawing schematically showing the cross sectional structure of a DVD or CD that is playback only. In the case of DVD the structure is two half-face discs laminated together, but only one of these half face discs is shown.

As shown in FIG. 3, a playback only disc has a transparent substrate layer 55, a reflecting layer 56, and a protective layer 57 (in the case of a laminated disc such as a DVD, a space layer) sequentially laminated from an incident surface side where laser light from an optical pick-up unit is incident. Main data signals are stored on the reflecting layer 56 using pits and lands.

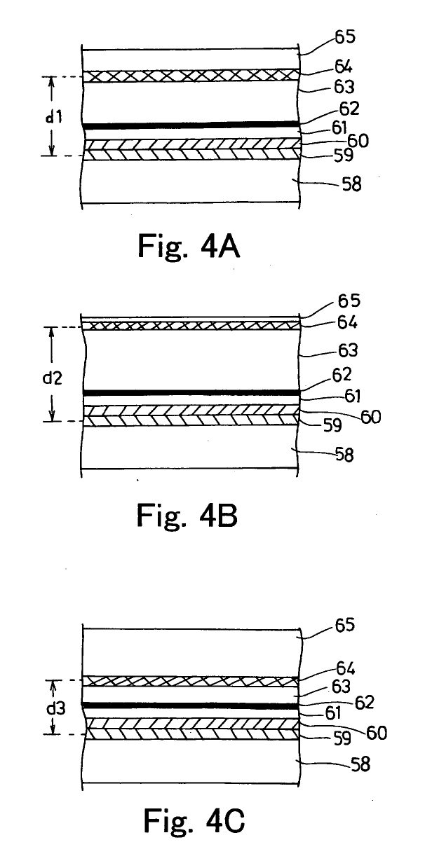

FIGS. 4A, 4B and 4C are explanatory drawings schematically showing cross sectional structure of storage discs with label layers of respectively different systems. Here, an example of DVD-R/DVD+R is shown, and the structure is two half-face discs of differing structure laminated together.

As shown in FIGS. 4A, 4B and 4C, the storage discs provided with a label layer have a structure with a first transparent substrate layer 58, a storage layer 59, a reflecting layer 60, a first protective layer 61, an adhesive layer 62, a second transparent substrate layer 63, a label layer 64 and a second protective layer 65 laminated sequentially from an incident surface where laser light from the optical pickup is incident, and the order is the same for each layer.

However, as shown in FIGS. 4A, 4B and 4C, the storage discs with label layer of each system have the label layer 64 in a different position, and respectively have distance from the storage layer 59 to the label layer 64 of d1, d2 and d3.

In FIG. 2 and FIG. 4, the storage layers 52, 59 are made using organic dye. Preformat signals storing positional information are formed in the storage layers 52, 59 using wobble. Main data signals are stored on the storage layers 52, 59 by decomposing the organic dye to form storage pits utilizing heat generated by focusing and irradiating laser light.

In FIG. 2 to FIG. 4, the reflective layers 53, 56, 60 are provided so that light intensity of laser light incident on the disc and received by the optical detectors 15, 3 is sufficient. In the case of the playback only disc shown in FIG. 3, storage pits storing main information signals are formed in the reflective layer 56.

Also, in FIG. 4 the laser layer 64 is formed using a heat sensitive agent having a heat sensitive effect for heat generated by focusing and irradiation of laser light for CD, or a light sensitive agent having a light sensitive effect to the wavelength of laser light for CD. The reflective layer 60 is translucent, and the adhesive layer 62 is transparent. Because of this, laser light for CD that is incident from the incident surface side reaches the label layer 64, and a visible image is formed in the label layer 64 using the color changing effect of the heat sensitive agent of light sensitive agent.

A playback circuit of the label information storage unit of FIG. 1 will now be described.

A front end processing circuit 21 receives respective received light outputs obtained from specified light receiving regions of the photo detector 15 of the DVD system, creates various DVD system control signals for the optical pickup, namely a focusing control signal, tracking control signal, and tilt control signal, and supplies the various DVD system control signals to a servo circuit 22. The servo circuit 22 selects various DVD system control signals for receiving light corresponding to a disc identification signal representing the type of disc that is the object of storage or playback, and also switches to a respectively appropriate equalizer setting according to the disc type for the selected DVD system control signals, and generates respective servo signals to cause operation of a focus servo, tracking servo and tilt servo appropriate for handling the disc type.

On the other hand, the front end processing circuit 21 receives respective received light outputs obtained from specified light receiving regions of the photo detector 3 of the CD system, creates various CD system control signals for the optical pickup, namely a focusing control signal and tracking control signal, and supplies the various CD system control signals to a servo circuit 22. The servo circuit 22 selects various CD system control signals for receiving light corresponding to a disc identification signal that is the object of storage or playback, and also switches to respectively appropriate equalizer setting according to the disc type for the selected CD system control signals, and generates respective servo signals to cause operation of a focus servo and a tracking servo for handling the disc type.

Various servo signals from the servo circuit 22 are supplied to an actuator driver 23, formed into respective drive signals for driving actuators (not shown) of the objective lens 13, and supplied to drive coils corresponding to various drive coils 24 of the actuators, such as a focus coil, tracking coil and tilt coil. The objective lens 13 is therefore driven by operation of the actuator in a focus direction based on the focus servo signal, in a tracking direction based on the tracking servo signal, and in a radial skew direction based on the tilt servo signal.

The front end processing circuit 21 also respectively binarizes an RF signal that is a DVD storage signal obtained by performing calculation processing on received light outputs of the specified regions of the DVD system photo detector 15, an RF signal that is a CD storage signal obtained by performing calculation processing on received light outputs of the specified regions of the CD system photo detector 3, and supplies the binarized signals to an encoding/decoding circuit 30 of a final stage.

The binarized DVD RF signal is subjected to decode processing by a DVD decoder section 31 of the encoder/decoder circuit 30 in response to modulation code and error correction code, based on a data format of the corresponding DVD standard. The DVD standard adopts EFM-Plus (8-16 modulation) as modulation code, and RS (Reed-Solomon) Product-Code as error correction code.

On the other hand, the binarized CD RF signal is subjected to decode processing by a CD decoder section 32 of the encoder/decoder circuit 30 in response to modulation code and error correction code, based on a data format of the corresponding CD standard. The CD standard adopts EFM (Eight to Fourteen modulation) as modulation code, and CIRC (Cross Interleaved Reed-Solomon Code) as error correction code.

With this embodiment, the type of storage media is determined based on storage media code stored using wobble, a specified on of the first and second laser drivers is selected in response to this determination, and writing to the label layer is carried out using laser light of a wavelength appropriate to the response of the label layer of the determined storage media (light sensitive, heat sensitive) The front end processing circuit 21 supplies specified received light outputs from the optical detector 15 and the optical detector 3 containing storage disc preformat signals for DVD and CD, namely wobble land pre-pit in the case of a DVD-R/RW minus system DVD, or groove wobble in the case of a DVD+R/RW plus system DVD or CD-R/RW, to a wobble detection circuit 25.

The wobble detection circuit 25 extracts a wobble signal from the preformat signal. The wobble signal is subjected to decode processing by an LPP/ADIP decoder 26 in the event that the storage disc is a DVD, or subjected to decode processing by an ATIP decoder 27 in the event that the storage disc is a CD. The LPP/ADIP decoder 26 comprises an LPP decode section for subjecting LPP (Land Pre-Pit) and wobble of a minus system DVD to decode processing, and an ADIP decode section for subjecting ADIP (Address in Pre-Groove) of a plus system DVD to decode processing.

Respective synchronous detection is carried out using LPP and wobble in the LPP decode section, and using wobble only in the ADIP decode section, address information is acquired, and an address signal is generated to constitute the basis for generating a storage timing signal for causing storage synchronized to this address information.

On the other hand, the ATIP decode section 27 subjects the ATIP (Absolute Time In Pre-Groove) of the CD to decode processing, synchronous detection is carried out using wobble, and an address signal is generated to constitute the basis for generating a storage timing signal for causing storage synchronized to this address information.

In the wobble of various storage discs, identification information such as the disc manufacturer, disc type etc. is contained at specified regions, and this identification information is decoded using a disc discrimination section 29 provided inside a control CPU 28 (Central Processing unit).

A storage circuit of the label information storage unit of FIG. 1 will now be described.

Raw data input via an interface 34 from a host device 33 such as a personal computer or the like is temporarily stored in a buffer RAM 36 as required, under management by a memory management circuit 35, and supplied to an encoder/decoder circuit 30.

When carrying out storage to a storage disc, the type of storage disc used, or data selected by the control CPU 28 in response to user selection, form either the DVD encoder section 37 or the CD encoder section 38, is transferred and the selected encoder section is operated.

Therefore, if the storage disc is a DVD, or even if it is a CD and the user has selected storage of DVD data, encoding processing is carried out by the DVD encoder section 37 based on the data format of the DVD standard, and DVD data having a data structure conforming to this data format is generated. On the other hand, if the storage disc is a CD, or even if it is a DVD and the user has selected storage of CD data, encoding processing is carried out by the CD encoder section 38 based on the data format of the CD standard, and CD data having a data structure conforming to this data format is generated.

DVD data or CD data created by the DVD encoder section 37 or the CD encoder section 38 is serially transferred to a write strategy circuit 39 at the storage timing, and this write strategy circuit 39 controls a drive pulse generating circuit 40 based on the transferred serial data, and drive pulses are generated by the drive pulse generating circuit 40 in a waveform to form optimum pits on the disc based on the DVD data or the CD data.

Drive pulses generated by the drive pulse generating circuit 40 are supplied to one of the first laser driver amp 42 and the second laser driver amp 43 selected by the switch 41, and are output by the selected laser driver amp as current signal drive pulses. The current signal drive pulses are then added to a high frequency signal generated from an OSC (oscillator) for superimposition 44, and supplied to the DVD.

The switch circuit 41 performs switching according to a disc type identified by the disc determination function 29 of the control CPU 28, and if the disc is a DVD type storage disc the first laser driver amp 42 is selected, while of the disc is a CD type disc the second laser drive amp 43 is selected.

On the other hand, the superimposition OSC 44 controls oscillation timing as required by the write strategy circuit 39 and the control CPU 28, and generates a high frequency signal having amplitude and oscillation frequency set in response to the disc type and the storage speed.

The switch circuit 41, first laser drive amp 42, second laser drive amp 43 and superimposition OSC 44 are provided inside a laser driver IC 45.

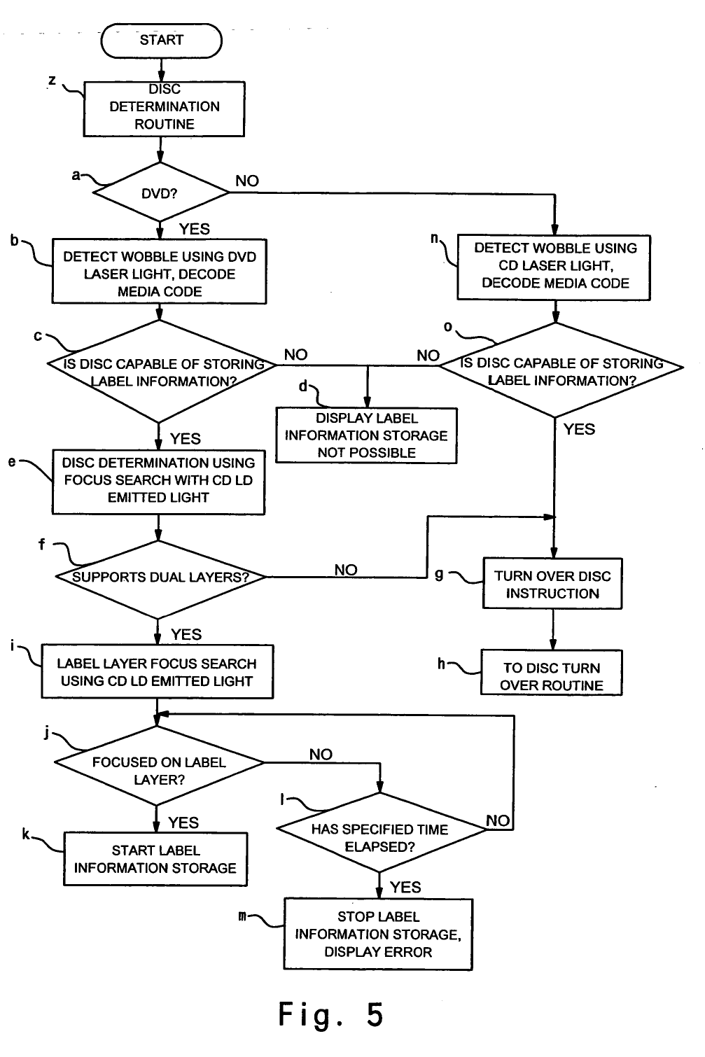

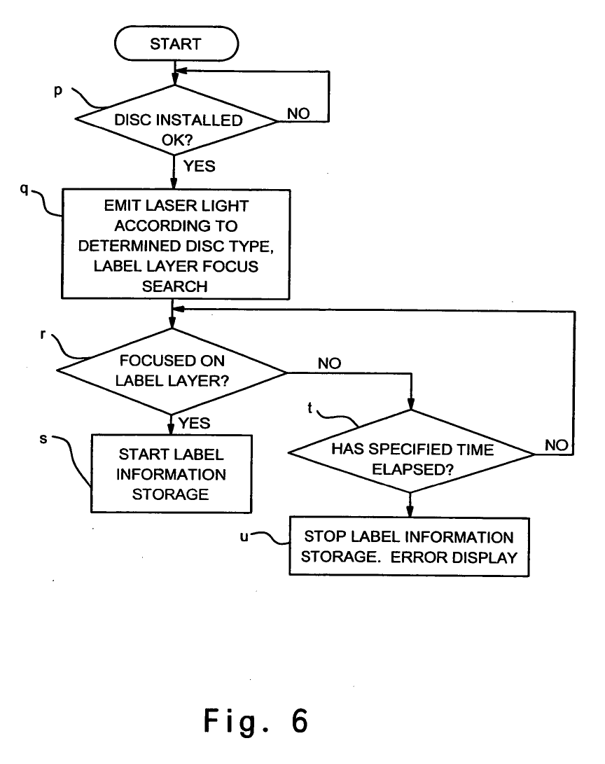

In label information storage unit having the structure shown in FIG. 1 described above, when carrying out label information storage processing shown in the flowcharts of FIG. 5 and FIG. 6 is executed.

Disc determination processing is executed as front-end processing for label information storage (step Z). This disc determination processing is executed by the disc determination function 29, and utilizes a widely known disc determination method, for example, determining whether or not a peak value of a focus error signal, obtained by focus search that causes movement of a laser light focus position using one laser diode to move in a focus direction, has reached a threshold value, or, as shown in Japanese patent laid-open No. 2000-173163, determining whether or not a maximum value for amount of variation per unit time of a focus error signal at the time of executing focus search using an arbitrary laser diode has reached a reference value.

It is determined from this disc determination processing whether the disc is a DVD or a CD (step a), the switch circuit 41 is switched by the control CPU 28 according to the disc type, and in the case of a DVD the first laser drive amp 42 is selected, while if the disc is determined to be a CD the second laser drive amp 43 is selected.

If the disc is determined to be a DVD, playback drive pulses output from the drive pulse generating circuit 40 are supplied to the first laser drive amp 42, and the DVD system first laser diode 1a is driven at a playback level. In this way, disc wobble due to disc writing using DVD laser light irradiated from the first laser diode 1a is detected by the wobble detection circuit 25, and media code is extracted by means of the LPP/ADIP decoder 26. This media code is decoded by the disc determination function 29 based on media code data stored in advance in ROM inside the control CPU 28, and it is determined what type of disc it is and by who it was manufactured (step b). It is then determined by the disc determination function 29 whether or not it is a disc having a label layer on which label information can be stored (step c).

If it is determined that is a disc without a label layer, data indicating that fact is supplied by the control CPU 28 to the host device 33 via the interface 34, and the fact that label information storage is not possible is displayed using a display device (not shown) provided in the host device 33 (step d) and label information storage is cancelled.

On the other hand, if it is determined to be a disc that has a label layer, the switch circuit 41 is switched by the control CPU 28 so as to select the second laser drive amp 43, the CD system second laser diode 2a is driven at a playback level by the second laser drive amp 43, and disc layer determination is carried out by the disc determination function 29 utilizing a focus search operation using the CD laser light (step e).

As shown in, for example, Japanese patent laid-open No. Hei.9-265722, this disc layer determination is carried out by detecting peak value and peak frequency of an S-curve of a focus error signal to ascertain the disc layer structure. At this time, focus search is performed to cause focus of laser light that is different from laser light suitable for writing the storage layer of the storage media on the label layer from the storage layer side of the storage media, and detecting the label layer. In the case of laser light of a wavelength used for writing to the storage layer, since this is a wavelength the storage layer responds to it can be expected that laser light of a wavelength that is not used in writing to the storage layer will have a larger amount of light passing through the storage layer than laser light at the writing wavelength, which is advantageous for focus search. For example, since it is confirmed that about 40% of the CD laser light incident from the DVD storage layer reached the label layer, if focus search is carried out using the CD laser light from the storage layer side a focus error signal of a sufficient signal level is obtained from the reflected light amount at the label layer, and disc layer determination can be carried out.

The type of storage media having a label layer is determined from a distance between the storage layer and the label layer of the storage media, and when it has been identified by this determination to be storage media having dual storage layers and label layers, laser light that is different from laser light suitable for writing to the storage layer of the storage media is irradiated from the storage layer side of the storage media to the label layer, and label information storage to the label layer is carried out. In the case of storage media having dual layers, since it is assumed that laser light will be irradiated to the label layer from the storage layer side, laser light of a wavelength that is different from the laser light suitable for writing to the storage layer is used. When it is determined from this determination that the storage media has a single storage layer and the label layer, a prompt to turn the storage media over is displayed, the fact that the storage media has been turned over is confirmed, a specified one of the first and second laser light is irradiated by the optical pick up from the label layer side of the storage media that is different from the storage layer side, and label information storage to the label layer is carried out. Specifically, whether the DVD storage disc having a label layer has the cross-sectional structure of FIG. 4a, FIG. 4B or FIG. 4C is revealed. Specifically, storage discs with a label layer of the respectively different systems of FIG. 4A, FIG. 4B and FIG. 4C are different from each other with respect to the distance between the storage layer 59 (or reflective layer 60) and the label layer 64, and so whether the disc is of the type shown in FIG. 4A, FIG. 4B or FIG. 4C is determined by making the speed at which the focal point of laser light used for laser search is moved these differing distances constant, and detecting temporal distance of peak value of an S-curve of a focus error signal respectively represented by the storage layer 56 (or reflective layer 60) and the label layer 64 at the time of this focus search.

In the event that this disc layer determination determines the disc to not be a DVD handling dual layers assuming irradiation of laser light to the label layer from the storage layer side (step f), that determination data is supplied by the control CPU 28 to the host device 33 via the interface 34, an instruction to turn over the disc is displayed using the display device (not shown) provided in the host device 33 (step g), and processing transfers to disc turnover processing shown in FIG. 6 (step h).

If the disc is determined by the disc layer determination to be a DVD supporting dual layers (step f), focus search is executed again (step i), and a focus servo to focus CD laser light on the label layer 64 is operated (step j). After that, the CD system second laser diode 2a is driven in accordance with the label information data, and label information storage is carried out to the label layer 54 using the CD laser light.

Focus servo operation for CD laser light to the label layer 54 is tried for a specified time (step l), and if focus servo operation fails in this time label information storage is abandoned, this fact is supplied to the host device 33, and a label information storage error is displayed using the display device provided in the host device 33 (step m).

In a state where label information storage is carried out using the CD laser light, label information data corresponding to a visible image (including characters) stored on the label layer 64 is generated by the host device 33, and that label information data is supplied to the CD encoder section 38 through the buffer RAM 36 via the interface 34.

The CD encoder section 38 performs encoding processing on the supplied label information data, and generates CD modulation label information data having a data structure conforming to the CD standard data format. This CD modulation label information data is supplied to the write strategy circuit 39. The write strategy circuit 39 controls the drive pulse generating circuit 40 to cause generation of drive pulses having an optimum storage waveform stored in advance taking into consideration the storage characteristics of the label layer 64. Drive pulses generated by the drive pulse generating circuit 40 are then supplied to the second laser drive amp 43 by switching of the switch circuit 41, and the CD system second laser diode 2a is driven by a laser drive signal that is a high frequency signal generated from the superposition oscillation circuit 44 as required on the output signal from the second laser drive amp 43. As a result, storage marks are formed on the label layer 64 of the disc based on the CD modulation label information data to store a visible image.

In step a of FIG. 5, if the result of disc determination processing is that a CD is determined, the switch circuit 41 is switched by the control CPU 28, and the second laser drive amp 43 is selected. Therefore, playback drive pulses output from the drive pulse generating circuit 40 are supplied to the second laser drive amp 43, and the CD system second laser diode 2a is driven at a playback level. In this way, disc wobble due to disc reading using the CD laser light output from the second laser diode 2a is detected by the wobble detection circuit 25, and media code is extracted via the ATIP decoder 27. This media code is decoded by the disc determination function 29 based on media code data stored in advance in the ROM inside the control CPU 28, and it is determined who the disc was manufactured by, and the type of disc (step n). It is then determined by the disc determination function 29 whether or not it is a disc with a label layer capable of storing label information (step o).

If it is determined to be a disc that does not have a label layer, data indicating that fact is supplied by the control CPU 28 through the interface 34 to the host device 33, the fact that label information storage is not possible is displayed using the display device provided in the host device 33 (step d) and label information storage is stopped.

On the other hand, if it is determined to be a disc with a label layer, that determination data is supplied by the control CPU 28 to the host device 33 via the interface 34, an instruction to turn over the disc is displayed using the display device provided in the host device 33 (step g), and processing transfers to disc turnover processing shown in FIG. 6 (step h).

If a disc tray for turning over the disc installed in the disc drive is opened and closed, the disc turnover processing shown in FIG. 6 is executed. If a disc installed OK instruction is input from the host device 33 (step p), the switch circuit 41 is switched to generate laser light corresponding to the disc type based on disc type data stored in the RAM inside the control CPU 28 at the time of disc determination processing (step Z in FIG. 5), and focus search is carried out for the label layer 64 using that selected laser light (step q).

Specifically, in the case where DVD has been determined, the first laser drive amp 42 is selected by the switch circuit 41, the DVD system first laser diode 1a is driven with a playback drive signal by the first laser drive amp 42 and focus search is carried out with DVD laser light driven at a playback level, while if a CD has been determined, the second laser drive amp 43 is selected by the switch circuit 41, the CD system second laser diode 2a is driven with a playback drive signal by the second laser drive amp 43 and focus search is carried out with CD laser light driven at a playback level.

A focus search servo is operated by this focus search to focus the laser light on the label layer 64 (step r). After that, in the event that DVD is determined, the DVD system first laser diode 1a is driven and label information storage is carried out to the label layer 64 using DVD laser light according to label information data, while if CD has been determined the CD system second laser diode 2a is driven and label information storage is carried out to the label layer 64 using CD laser light according to label information data (step s).

In carrying out label information storage using laser light supporting the disc type in this way, writing to the label layer 64 is carried out using laser light of a wavelength that can be expected to be suitable to the sensitivity ‘(light sensitive, heat sensitive) of the label layer 64. Specifically, there is a wavelength dependency where degree of sensitivity to laser light wavelength varies depending on the material properties of the material used in the label layer 64, or since aperture diameter varies depending on laser light wavelength laser light exists of a wavelength suitable for carrying out writing to the label layer 64, and in this case, label information storage is supported to discs with label layers of various systems due to the fact that laser light is used of a wavelength that supports the disc type, while carrying out writing to the label layer 64 using laser light of a wavelength having a high possibility of being suitable.

Focus servo operation to the label layer 64 is tried for a specified time (step t), and if focus servo operation fails in this time label information storage is abandoned, this fact is supplied to the host device 33, and a label information storage error is displayed using the display device provided in the host device 33 (step u).

With the label information storage unit shown in FIG. 1, in the case of carrying out label information storage to the label layer 64 of a DVD supporting dual layers CD laser light is irradiated from a storage layer 59 side of the disc, as CD storage circuitry is used. At this time, the DVD system first laser diode 1a is not used and the DVD storage circuitry is redundant. Therefore, together with transmitting label information data from the host device 33 to the CD encoder section 38, main data is transmitted from the host device 33 to the DVD encoder section 37, with the label information data and the main data being transmitted in a time divided manner, the switch circuit 41 is switched depending on whether the drive pulses output from the drive pulse generating circuit 40 correspond to main data or correspond to label information data, and by driving the DVD first laser diode 1a at a level for storing to the storage layer 59 and driving the CD system second laser diode 2a at a level for storing to the label layer 64 in a time divided manner, it is possible to store main data to the storage layer 59 while storing to the label layer 64 is a time-divided manner.

Also, at the time of label information storage, as well as the possibility of separately using the DVD system first laser diode 1a, there is a possibility of separately using DVD circuitry. Therefore, in the case of a DVD supported label information storage with main data already written, main data is played back instead of main data storage, while storing to the label layer 64, in a time divided manner.

Here, in the case of carrying out storage to the label layer 64 while storing main data to the storage layer 59 in a time divided manner, it is necessary to focus the DVD laser light on the storage layer 59 at the time of main data storage, and to focus the CD laser light on the label layer 64 at the time of label information storage.

Also, in the case of carrying out storage to the label layer 64 while playing back main data to the storage layer 59 in a time divided manner, it is also necessary to focus the DVD laser light on the storage layer 59 at the time of main data playback, and to focus the CD laser light on the label layer 64 at the time of label information storage.

Normally, focus control is carried out to focus the DVD laser light and the CD laser light on the storage layer 59 and the label layer 64 respectively in a time divided manner depending on the laser driver amp being driven.

On the other hand, in the circuit of FIG. 1, when the first laser diode 1a and the second laser diode 2a are driven at the same time, it is also possible to simultaneously focus the DVD laser light and the CD laser light on the storage layer and label layer respectively of the DVD.

If the DVD focus servo system is operated, the objective lens 13 is driven so as to focus the DVD laser light on the DVD storage layer 59, a focus servo carried out, a focal distance of the DVD laser light and the CD laser light focused by the objective lens 13 at a fixed position is different, due to differing wavelength with DVD and CD, and due to optical design based on differing thickness of the transparent substrate up to the storage layer. Accordingly, in a focus servo state of a DVD where storage and playback are carried out for the DVD, the focal point of the CD laser light is at a position far away from the focal point of the DVD laser light.

Then, a liquid crystal driver 47 is operated in response to an optical path length adjustment signal generated by an optical path length adjustment circuit 46, a distance between the focal point of the CD laser light and the focal point of the DVD laser light is increased due to the fact that the liquid crystal lens 17 operates as a concave lens, and with the disc of FIG. 4(a), in a state where the DVD laser light is focused on the storage layer 59 of the DVD, the focal point of the CD laser light is aligned with a reference position of the label layer 64 of the DVD, namely, when the first laser diode 1a and the second laser diode 2a are driven at the same time, the DVD laser light and the CD laser light can be respectively focused on the storage layer 59 and label layer 64 of the DVD at the same time.

As a result, when carrying out storage of main data to the storage layer 59 or playback of main data from the storage layer 59 using the DVD system focus servo, while carrying out storage to the label layer 64 in a time divided manner, it is not necessary to perform focus control of the DVD laser light on the storage layer 59 the CD laser light on the label layer 64 in a time divided manner.

Also, two systems, namely a DVD system and a CD system, capable of operating at the same time are provided in the write strategy circuit 39 and the drive pulse generating circuit 40, and if a circuit structure is provided with the switch circuit 41 removed, for simultaneously supplying drive pulses generated by the drive pulse generating circuit to the first laser drive amp 42 and the second laser drive amp 43, it is possible to simultaneously carry out storage to the label layer 64 while carrying out main data storage to the storage layer 59 in the event that the DVD laser light and the CD laser light are simultaneously focused on the storage layer 59 and label layer 64, respectively, of the DVD.

Since it is not necessary for label information storage to be as highly accurate as main data storage, it can be realized even if the CD laser light spot diameter becomes large due to focus variation within a permissible range.

Also, in the case where DVD laser light and CD laser light are simultaneously focused on the storage layer 59 and label layer 64, respectively, of the DVD, a focus error signal for the CD light with respect to the label layer 64 is generated by a front end processing circuit 21 using specified received light outputs received using the optical detector 3 inside the light emitting and receiving unit 2, the liquid crystal driver 47 is controlled by the optical length adjustment circuit 46 based on this focus error signal, and the liquid crystal lens 17 is driven to vary operation of the concave lens so that the focus error signal approaches “0”. In this manner, it is possible perform focus control of the CD laser light on the label layer 64 independently of focus control of the DVD laser light on the storage layer 59 of the DVD using the liquid crystal lens 17.

If concave lens operation of the liquid crystal lens 17 is provided for each disc, taking into consideration reaction rate of liquid crystal elements inside the liquid crystal lens 17, it is possible to avoid the influence of erroneous variation in thickness between discs, even if it is not possible to handle surface fluctuations of the disc. If concave lens operation of the liquid crystal lens 17 is set for every specified position in a radial direction of disc storage and playback positions, it is also possible to avoid the effects of warping of a disc in the radial direction of the disc.

As described above, according to this embodiment, in writing to a label layer of storage media it is possible to selectively use either of first laser light or second laser light, which means that it is possible to select laser light of a wavelength suitable for the sensitivity of the label layer, and use it in label information storage.

Also, since laser light that is different from laser light suitable for writing to the storage layer detected the label layer from the storage layer side of the storage media, a light amount passing through the storage layer is ensured, which is advantageous in detecting a label layer from the storage layer side.

Further, since storage media having dual layers is identified, in the case of storage media having dual layers, laser light of a wavelength that is different to laser light suitable for writing to the storage layer is used and laser light is irradiated to the label layer from the storage layer side, together with being able to carry out label information storage without turning the disc over, it is possible to carry out label information storage simultaneously with signal storage or signal playback by simultaneously driving the first and second laser light sources. Also, since storage media having single layers is identified, in the case of storage media having single layers, since a prompt to turn the storage media over is displayed, turning over of the storage media is confirmed and storage of label information is carried out from the label layer side different from the storage layer side of the storage media, it is possible to effectively carry out storage of label information to storage media having a single layer. In this case, since at the time of label information storage to the label layer laser light suitable for writing to the storage layer is used as a result of disc determination, laser light of a wavelength that can be expected to be suitable for the sensitivity of the label layer is used, and the possibility of effectively being able to execute storage of label information is high.

What is claimed is:

1. A label information storage unit, provided with an optical pickup having a first laser light source and a second laser light source for respectively emitting laser light of a first wavelength and a second wavelength that are different from each other, for storing label information to a label layer irradiation of one of the first laser light and the second laser light using the optical pickup for a storage media provided with a label layer capable of being written with label information as a visible image, wherein
one of a first laser driver and a second laser driver for respectively driving the first laser light source and the second laser light source is selected according to a type of storage media constituting an object of processing, drive pulses are generated from the selected laser driver based on label information, and label information is written to a label layer of the storage media, constituting an object of processing, using laser light output by driving one of the first laser light source and the second laser light source with the drive pulses.

2. The label information storage unit of claim 1, wherein
type of storage media is determined based on storage media code stored utilizing wobble in storage media that constitutes an object of processing, and one of the first laser driver and the second laser driver is selected in response to the result of determination.

3. The label information storage unit of claim 1, wherein
focus search is carried out to focus laser light that is different from laser light suitable for writing to a storage layer of storage media constituting the object of processing from a storage layer side of the storage media that constitutes the object of processing, and a label layer of the storage media constituting the object of processing is detected.

4. The label information storage unit of claim 1, wherein
in the event that the type of storage media constituting the object of processing is determined from a distance between the storage layer and the label layer of the storage media constituting the object of processing, and it has been identified that the storage media constituting the object of processing is storage having dual storage layers and label layers, laser light that is different from laser light suitable for writing to the storage layer of the storage media constituting the object of processing is irradiated from the storage layer side of the storage media constituting the object of processing to the label layer, and label information storage to the label layer is carried out.

5. The label information storage unit of claim 1, wherein
the type of the storage media constituting the object of processing is determined based on a distance between the storage layer and the label layer of the storage media constituting the object of processing, and in the event that the storage media constituting the object of processing is identified as storage media having a single storage layer and label layer display prompting turning over of the storage media constituting the object of processing is carried out, and after it has been confirmed that the storage media constituting the object of processing has been turned over one of the first laser light and the second laser light is irradiated from a label layer side different from the storage layer side of the storage media constituting the object of processing to the label layer of the storage media constituting the object of processing, and label information is stored.

6. The label information storage unit of claim 5, wherein
a specified on of the first laser driver and the second laser driver is selected to use laser light suitable for writing to a storage layer as a result of determination of the storage media constituting the object of processing.
